(19) United States
(12) Patent Application Publication
(10) Pub. No.: US 2006/0202375 A1
(43) Pub. Date: Sep. 14, 2006

(54) Extruded and shaped earplug

(76) Inventor: John Allen Jenkins JR., San Diego, CA (US)

Correspondence Address: LEON D. ROSEN;FREILICH, HORNBAKER & ROSEN, Suite 1220, 10960 Wilshire Boulevard, Los Angeles, CA, 90024, US

(21) Appl. No.: 11/361,210

(22) Filed: Feb. 24, 2006

Related U.S. Application Data
(60) Provisional application No. 60/661,402, filed on Mar. 14, 2005.

(51) Int. Cl. B29C 47/00

(52) U.S. Cl. 264/148; 264/320; 425/441

(57) ABSTRACT

Earplugs are formed by extruding an elastomeric material (12) forwardly (F) through an extrusion head (14) so a forward portion of the extrusion enters a shaping cavity (50A). The forward portion of the extrusion is severed from the rest of the mass being extruded to form a globule. The globule is allowed or forced to expand in the cavity, or the cavity is formed of parts that compress the globule, to shape the globule to the shape of the cavity.

### CROSS-REFERENCE

Applicant claims priority from U.S. Provisional patent application 60/661,402 filed Mar. 14, 2005.

### BACKGROUND OF THE INVENTION

Earplugs, especially those formed of foam, can be molded to an accurately controlled shape by pouring liquid, or flowable, foamable material into a mold cavity and quickly closing the cavity. The foamable material expands to fill the mold cavity, to produce an accurately formed earplug in the shape of the mold cavity. The rate at which earplugs are formed is limited by the time required for a liquid dispenser of foamable material to dispense the required amount of liquid before moving from one cavity to the next and the time required for the foamable material to completely foam and fill the cavity. Earplugs of non-foam elastomeric material also can be molded.

Earplugs of foam are usually disposable, in that they are typically disposed of every time a worker leaves for lunch or other break, the worker taking another pair when he/she returns. A suitable liquid foamable material is a water-reacting polymer, which is a material that is not biodegradable. Many people prefer to use biodegradable material for disposable items, but applicant does not know of a liquid foamable polymer with a sufficiently low viscosity to rapidly pour into a mold cavity. A method for forming earplugs rapidly and using biodegradable material for the earplugs would be of value.

### SUMMARY OF THE INVENTION

In accordance with one embodiment of the invention, a method and apparatus for forming earplugs are provided that enable a high rate of earplug production for low cost, and that enable the use of high viscosity liquid foamable polymer so biodegradable material can be used. The flowable earplug material is extruded through an extrusion head, and a front portion of the extrusion is immediately separated from the rest of the mass that is being extruded, to form a globule. The globule is immediately received through a cavity opening into a cavity. The cavity is closed and the globule is allowed to fill the cavity to form an earplug. The cavity is opened to allow earplug removal.

The novel features of the invention are set forth with particularity in the appended claims. The invention will be best understood from the following description when read in conjunction with the accompanying drawings.

### BRIEF DESCRIPTION OF THE DRAWINGS

FIG. 1 is a sectional side view of an extrusion head, showing the production of a globule.

FIG. 2 is a view similar to that of FIG. 1 but with a produced globule separated from the rest of the material being extruded.

FIG. 3 is a rear elevation view of the blades of a cutter, or separator of FIG. 1, with the separator shown in its open position.

FIG. 4 is a view similar to FIG. 3 but with the blades in a closed position.

FIG. 5 is a partial sectional view of a system for molding globules of he type shown in FIG. 2.

FIG. 6 is a front-isometric view of the system of FIG. 5.

FIG. 7 is a partial sectional view of a system for molding earplugs of a second embodiment of the invention.

FIG. 8 is a partial sectional view of a system for molding earplugs of a third embodiment of the invention.

### DESCRIPTION OF THE PREFERRED EMBODIMENTS

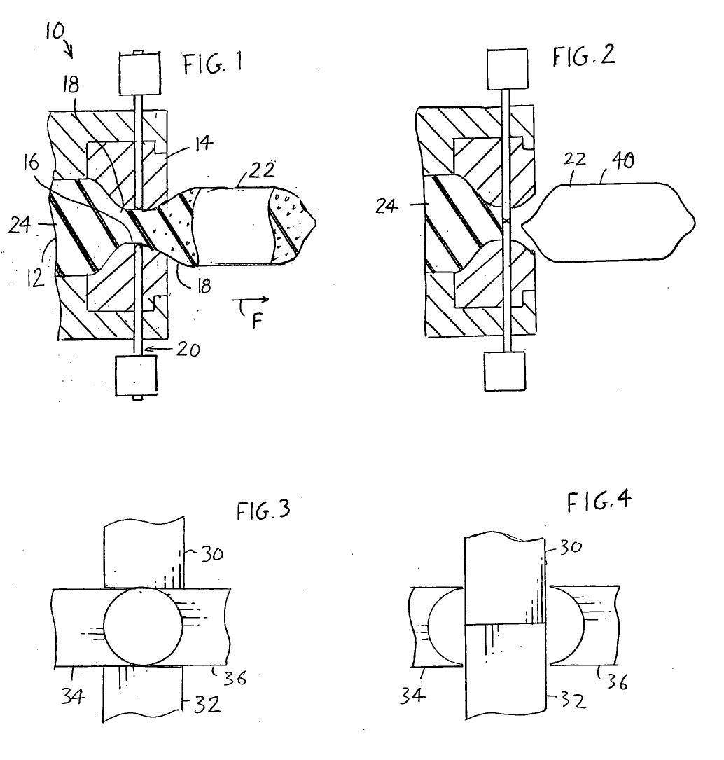

FIG. 1 illustrates an extrusion apparatus 10 of the invention and a quantity 12 of elastomeric material that is being extruded by the extrusion apparatus. The material is an elastomeric material that is, it has a Young's Modulus of Elasticity of no more than 50,000 psi, when the material solidifies. The particular elastomeric material 12 is a foamable material. The extrusion apparatus includes an extrusion head 14 with an opening 16 that forms a largely cylindrical extrusion 18 that continues to foam and expand after it is extruded from the head 14. The extrusion apparatus includes a separation device 20 that separates a front portion 22 of the extrusion from the mass 24 that is being extruded to form globules 40. The front portion 22 of the extrusion and the globule 40 are the same portion of the quantity 12 of material. FIGS. 3 and 4 show one example of a separation device, which includes a first pair of plates or blades 30, 32 and a second pair 34, 36. The second pair 34, 36 maintains a circular extrusion opening shape during most of the extrusion. The first pair of blades 30, 32 closes the exit area of the extrusion head when the first blades are brought together (and the second pair of blades are separated). An advantage of the particular separation device 20 is that the second pair of blades briefly closes the extrusion head to stop or greatly slow the advance of the front portions of the extrusion, or globules. Also, the blades cut the extrusion before it has begun solidifying.

FIG. 2 shows a fully separated elongated extrusion front portion 22, or globule 40 that is produced as a result of the extrusion and separating processes. A succession of such elongated globules are produced. It is possible to merely allow the elongated globules to finish foaming and completely solidifying (e.g. while they fall in the air) to become earplugs. However, the shapes of the elongated globules cannot be closely controlled in that way.

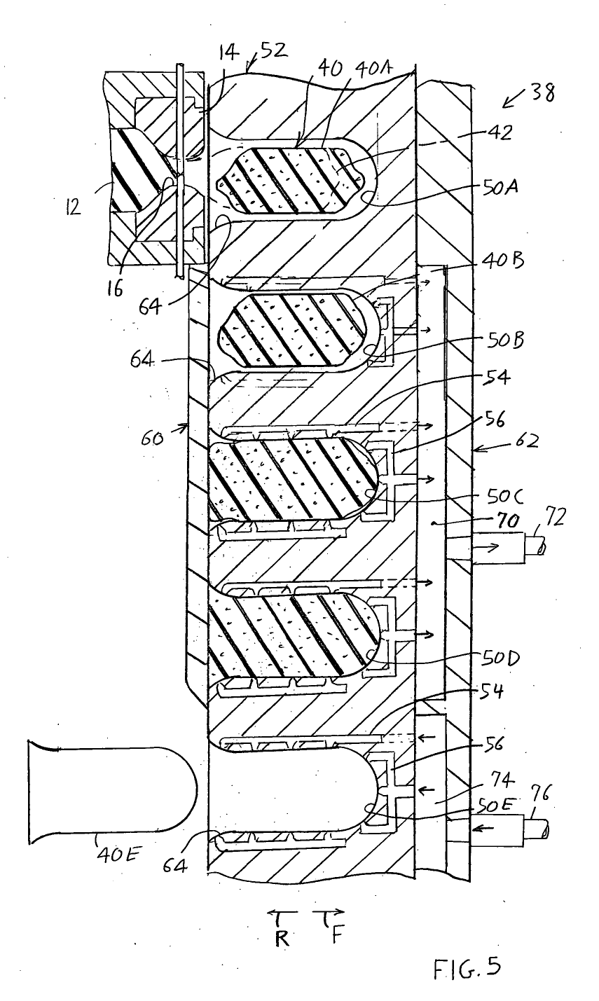

FIG. 5 illustrates a manufacturing system and method 38 that uses the elongated globules 40 that were produced by extrusion and separation of the extrusion into sections, while the material has not yet fully solidified, to form earplugs of closely controlled shape. A first step is to extrude a length of material and separate it to form the front extrusion portion, or elongated globule at 40A. The elongated globule is extruded and leaves the extrusion head directly into an open rear end 64 of a shaping cavity 50A of a multi-cavity element 52, or molder which may be in the form of a wheel. The cavity 50A is in line with the extrusion head opening 16. In FIG. 5, the extrusion front end 42 has already entered the cavity at 50A when the extrusion front portion is severed from the rest of the mass of material 12 being extruded. Immediately after the elongated globule moves into the cavity 50A by reason of its extrusion and severing, the wheel turns in a step of several degrees and momentarily stops. This allows the next extrusion front portion or elongated globule to be extruded into the next cavity. FIG. 5 shows a previous globule 40B as it is expanding in the previous cavity 50B.

In order to facilitate expansion of the elongated globule, applicant applies a vacuum at the walls of the cavities at cavity location 50B, 50C and 50D, through two sets of conduits 54, 56. The vacuum enhances expansion of the globule material, which has not yet fully solidified, to expand the globules against the walls of the cavities. Applicant prefers to use a foamable polymer in the system of FIG. 5, as such polymer helps the expansion of earplugs of such material. The result is that the globules expand to completely fill the cavities, to produce earplugs of well controlled shapes. It is possible to use sintered cavity wall material to distribute the vacuum.

When the globule reaches cavity 50E, it has been nearly fully solidified. One or more additional cavity locations may be provided between 50D and 50E to provide time for such solidification and for expansion. The cavity at 50E, wherein the rear end of the cavity is open, is subjected to pressured air flowing along the conduits 54, 56. The pressured air blows the earplug out through the now-open end 64 to move the earplug at 40E into a container (not shown) that holds finished, or nearly finished earplugs.

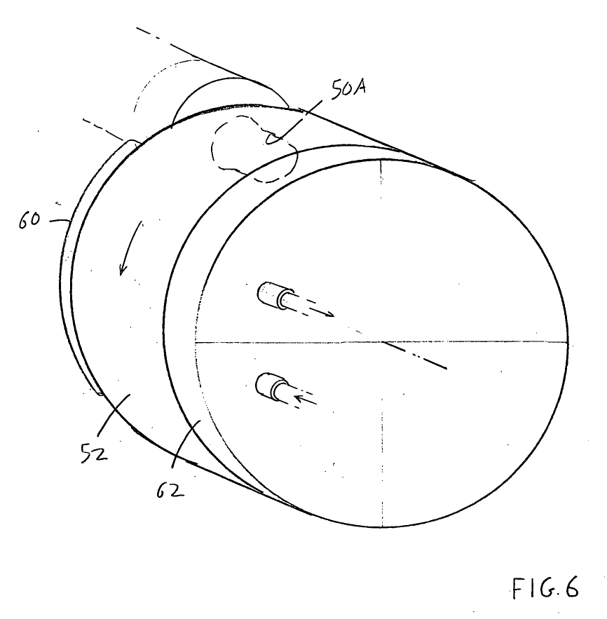

The system 38 of FIG. 5 includes two stationary plates 60,62 that lie against opposite faces of the rotatable cavity-forming element 52. The first plate 60 seals the rear ends 64 of the cavities along the locations 50B to 50 D where a vacuum is being applied. The second plate 62 forms a vacuum plenum 70 connected to a vacuum hose 72 that leads to a vacuum source, and a pressured air plenum 74 connected to a pressured air hose 76 that leads to a pressured air source. The plenums apply a vacuum or pressured air to the cavities, depending upon the cavity locations. A motor (not shown) rotates the element in steps. FIG. 6 shows the system, including the stationary plates 60, 62 and the rotatable element 52. The system can be oriented so the cavity rear ends face primarily upward or downward instead of primarily horizontally, although having the cavity rear ends face upward is preferred.

The production of earplugs by extrusion followed by shaping of the extrusion, enables a biodegradable material to be used for the earplugs. One such material is a polyurethane prepolymer which contains foaming agents, and which has too high a viscosity to enable it to be rapidly poured into molds for molding of earplugs. However such polyurethane prepolymer can be extruded using the process described above. The earplugs such as 40E of FIG. 5 are usually used as foam earplugs that are disposable. There is a demand for biodegradable disposable parts such as the above earplugs, and the above extrusion process enable this.

Although the process shown in FIG. 5 is preferably used for earplugs of foam material, the process is also useful for non-foamed, or “solid” elastomeric material, such as a silicone. In forming a solid elastomer, it is useful to use the above described process of extrusion with separation, as shown in FIGS. 1 and 2 to provide an elongated globule of the proper amount of material which is to constitute the earplug. Such extruded globule can be shaped in a cavity by compressing the still-flowable globule.

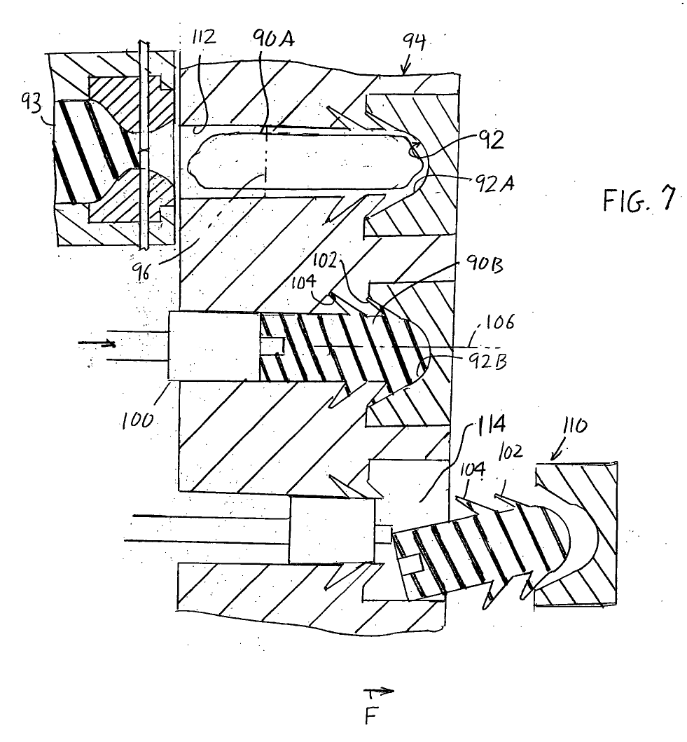

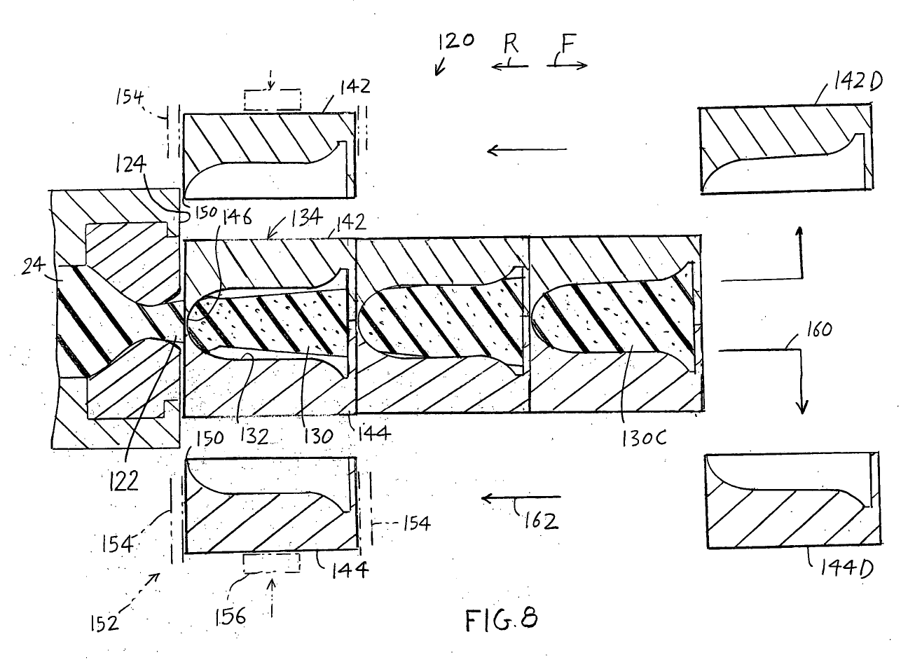

FIG. 7 shows an elongated front extrusion portion or globule 90A that has just been extruded into a cavity 92A of a molder 94 and which has been severed from a mass 93 being extruded. The molder 94 has cavities 90 and turns or otherwise moves in a step to bring the elongated globule and each cavity into second positions such as 90B. At the second positions, a piston or ram 100 forces the elongated globule deeper into the cavity so the material completely fills the front of the cavity which forms the earplug cavity 96. The particular cavity forms earplugs with flanges at 102, 104 which extend at a radially outward (with respect to the cavity axis 106) and rearward incline. As in the apparatus of FIG. 5, a vacuum can be used to aid in completely filling the cavity and pressured air can be used to blow out the earplug. It is possible to open the cavity by withdrawing a cavity-forming part 110 to facilitate earplug removal through an open front end 114 without damage. In this example, the globule enters one end portion 112 of the cavity and leaves through an opposite end 114.

FIG. 8 illustrates another system 120 wherein a foam extrusion 122 from an extrusion head 124 has its front portion, or extrusion section 130 severed from the mass 24, so its front portions or globules each lies in a cavity 132 of a mold 134. In this embodiment, the front end of the extrusion is severed by the mold parts 142, 144 of each mold as the mold parts move together to close the open cavity formed by the separated cavity walls formed by the mold parts. The rear end 146 of each mold part has a small length in directions, F, R, so the mold parts have edges at 150 that cut the extrusion. When the extrusion section at 130 has fully expanded to fill the cavity as at 130C and has partially or fully solidified, the mold parts separate at 142D, 144D and the molded earplug is blown out. The mold sections are then moved rearward for reuse. Vacuum may be applied to assure that the extrusion section fills the cavity. A mechanism 152 has side guides 154 that guide movement of the mold parts and a mover 156 that moves the parts together. The mechanism also moves the mold parts along arrows 160, 162.

Applicant uses the term “earplug” to define an element that is placed in the ear canal and that contacts the walls of the ear canal to help block sound. Some earplug devices include a separate part such as a stiffener rod extending along the earplug axis, that helps insertion of the earplug element into the ear canal.

Thus, the invention provides a method and apparatus for forming earplugs, which includes extruding into a forming cavity, a front portion of an extrusion of material that expands into and/or is forced to take the shape of the cavity, and that will solidify to become an earplug. In the cavity, expansion of the still-flowable extrusion section can be helped by vacuum and/or pressure of a ram, to cause the still-flowable material to fill the cavity and acquire the desired earplug shape. The methods not only facilitate the production of earplugs, but allow a viscous earplug material to be used, so an available biodegradable material can be used to produce earplugs, especially a disposable biodegradable foam material.

Although particular embodiments of the invention have been described and illustrated herein, it is recognized that modifications and variations may readily occur to those skilled in the art, and consequently, it is intended that the claims be interpreted to cover such modifications and equivalents.

What is claimed is:

1. A method for forming earplugs, comprising:
forming an extrusion of elastomeric material by extruding the elastomeric material forwardly through an extrusion head opening and separating a front portion of the extrusion from the rest of the elastomeric material;
allowing said front portion to enter an open cavity formed by cavity walls, closing the cavity, and flowing the separated extrusion front portion to fill the closed cavity to produce a formed mass of said material in the shape of an earplug;
removing said formed mass from the cavity after the formed mass in the shape of an earplug has at least partially solidified.

2. The method described in claim 1 wherein:
said step of allowing said front portion of the extrusion to enter an open cavity includes positioning the open cavity in line with said extrusion head opening so that while a rear end of the extrusion lies in an extrusion head opening, a front end of the extrusion has already entered the cavity.

3. The method described in claim 1 wherein:
said step of allowing said front portion of the extrusion to enter an open cavity formed by cavity walls, includes moving at least two mold parts that each forms part of the cavity, together around the extrusion as the extrusion is moving forward out of the extrusion head opening.

4. The method described in claim 1 wherein:
said step of allowing said front portion of the extrusion to enter an open cavity, and said step of separating a front portion of the extrusion, includes moving a pair of mold parts together form the cavity, while rear ends of the mold parts move together with the extrusion between them and sever the extrusion front portion from the rest of the extrusion.

5. The method described in claim 1 wherein:
said step of flowing the extrusion front portion to fill the closed cavity includes advancing a piston into a first part of the cavity to press the extrusion front portion further into the cavity.

6. The method described in claim 1 wherein said cavity has an axis and said cavity defines at least one flange on the outside of the shape of the earplug, with the flange extending at a radially outward and rearward incline, and wherein:
said step of allowing said front portion of said extrusion to enter an open cavity includes allowing the extrusion to pass through an open front end of a cavity; and
said step of removing includes opening a second end of said cavity which is opposite said front end of the cavity and ejecting said earplug through said second end of said cavity.

7. The method described in claim 1, wherein:
said step of separating includes moving at least one blade across said extrusion head opening to not only sever the extrusion front portion from the rest of the material, but to close said opening to the free outflow of material therethrough.

8. Apparatus for forming earplugs, comprising:
extrusion apparatus which includes an extrusion head for forming an extrusion of elastomeric material;
separator means positioned to separate the extrusion into separate globules;
a molder which has at least one part forming a plurality of cavities that are each changeable from a first open position to receive, into one of said cavities, a globule that has been extruded and separated, to a closed position wherein the cavity is closed with the globule lying inside, so the globule can fill the cavity to form an earplug, and to a second open position at which the cavity is open to allow the earplug formed by the globule to be removed.

9. The apparatus described in claim 8 wherein:
said molder includes a plurality of pairs of mold parts that form each of said cavities between one of the pairs, and a mechanism that moves a pair of the mold parts together immediately forward of the extrusion head to move around an extrusion front portion, and then moves the pair, with a globule therein, away from a position immediately forward of the extrusion head.

10. The apparatus described in claim 8 wherein:
said molder includes at least one piston that is movable in one of said cavities to compress a globule in the cavity to cause the globule to fill the rest of the cavity.
